(19) United States
(12) Patent Application Publication
(10) Pub. No.: US 2026/0168824 A1
(43) Pub. Date: Jun. 18, 2026

(54) OPTICAL ENCODERS AND DETECTOR SYSTEMS FOR DETECTING WAVELENGTH AND/OR POSITION OF A MOVEABLE LIGHT SOURCE, AND RELATED METHODS

(71) Applicant: GPD Optoelectronics Corp., Salem, MA (US)

(72) Inventors: David T. BEATSON, Portsmouth, NH (US); Peter E. DIXON, Bedford, NH (US); Gannon POND, Dorchester, MA (US)

(73) Assignee: GPD Optoelectronics Corp., Salem, MA (US)

(21) Appl. No.: 19/419,292

(22) Filed: Dec. 15, 2025

Related U.S. Application Data
(60) Provisional application No. 63/734,475, filed on Dec. 16, 2024.

(51) Int. Cl. G01D 5/347

(52) U.S. Cl. CPC G01D 5/34746

(57) ABSTRACT

An optical encoder and detector system is disclosed, comprising a lateral photodiode configured to receive monochromatic light and a linear variable optical filter positioned in the optical path between the light source and the photodiode. The system enables precise detection of the optical wavelength of the incident light, with embodiments utilizing multi-lane lateral photodiodes to improve wavelength resolution and detection speed. The encoder may include a cooling element, such as a thermoelectric cooler, to reduce noise and enhance measurement accuracy. Additional embodiments provide reference diodes for further accuracy and support both front side and backside illumination. The system can also detect the position, including angular position, of a moveable light source using current differences between anodes of the photodiode. These features allow for high-resolution, high-bandwidth, and robust optical wavelength and position detection across a range of applications.

### RELATED APPLICATIONS

This application claims the priority and benefit of U.S. Provisional Patent Application Ser. No. 63/734,475, titled “Optical Encoders And Detector Systems For Detecting Wavelength and/or Position Of A Moveable Light Source, And Related Methods” filed on Dec. 16, 2024, the contents of which are incorporated by reference in their entirety into this application.

### FIELD

The invention relates optical encoders and optical detector systems, and more particularly, to optical encoders and optical detector systems for detecting wavelength and/or a position of a moveable light source.

### BACKGROUND

Optical encoders and detector systems are widely used in various industries for the precise measurement of optical wavelengths and the detection of the position of light sources. Traditional optical encoders often rely on time-based measurement techniques or interferometric methods, such as Mach Zehnder Interferometers, to determine the wavelength of light. These conventional systems, while effective, can be limited in terms of resolution, speed, and sensitivity to changes in light intensity, and may require complex signal processing or moving parts to achieve high accuracy.

Recent advances in photodetector technology have enabled the development of lateral photodiodes and multi-lane lateral photodiodes, which offer improved performance characteristics for optical sensing applications. These devices can be fabricated from a variety of materials, such as silicon, indium gallium arsenide, or germanium, to provide sensitivity across a broad range of wavelengths. The integration of linear variable optical filters with lateral photodiodes allows for the selective filtering of incident light, enabling precise wavelength discrimination and measurement.

Despite these advancements, there remains a need for optical encoders and detector systems that can provide higher resolution, greater bandwidth, and improved accuracy in both wavelength and position detection. In particular, systems that can operate independently of light intensity and that are less susceptible to noise and environmental variations are highly desirable. Additionally, the ability to detect the position of moveable light sources, including both linear and angular positions, with high precision is important for a wide range of applications, including industrial automation, robotics, and scientific instrumentation.

The present disclosure addresses these needs by providing optical encoders and detector systems that utilize lateral photodiodes, multi-lane configurations, and linear variable optical filters. These systems are capable of achieving sub-nanometer resolution in wavelength detection and high linearity in position measurement, while also offering the benefits of reduced noise through cooling elements and enhanced accuracy with reference diodes. The disclosed embodiments represent a significant improvement over prior art systems, such as those described in U.S. Pat. No. 8,971,360, by enabling static, high-precision measurements that are robust to variations in light intensity and environmental conditions

### SUMMARY

According to an exemplary embodiment of the invention, an optical encoder is provided. The optical encoder includes a lateral photodiode configured to receive monochromatic light, and a linear variable optical filter disposed in a path between the monochromatic light and the lateral photodiode. The optical encoder is configured to detect an optical wavelength of the monochromatic light.

According to another exemplary embodiment of the invention, an optical detector system is provided. The optical detector system includes a light source configured to provide monochromatic light, and an optical encoder. The optical encoder includes (i) a lateral photodiode configured to receive monochromatic light from the light source, and (ii) a linear variable optical filter disposed in a path between the light source and the lateral photodiode. The optical encoder is configured to detect an optical wavelength of the monochromatic light. In certain embodiments of the invention, the optical detector may include: one or more optical elements configured to receive monochromatic light from the light source, and for directing the monochromatic light to the optical encoder; and/or a computer system configured to detect the optical wavelength of the monochromatic light.

According to other embodiments of the invention, the optical encoder recited in the immediately preceding two paragraphs may have one or more of the following features: the lateral photodiode is a multi-lane lateral photodiode; the multi-lane lateral photodiode improves a wavelength resolution detection of the optical wavelength; the multi-lane lateral photodiode provides an improved electrical bandwidth to increase the speed of detection of the optical wavelength; the monochromatic light received by the lateral photodiode is divided such that the monochromatic light varies by lateral position with respect to wavelength between two respective anodes of each lane of the multi-lane lateral photodiode, the linear variable optical filter being skewed with respect to the multi-lane lateral photodiode such that the division of the monochromatic light between the respective anodes of each lane varies across each lane of the multi-lane lateral photodiode; a cooling element to cool the lateral photodiode; the cooling element includes a thermo electric cooler, the lateral photodiode being mounted on the thermo electric cooler; the monochromatic light received by the lateral photodiode is divided between two anodes of the lateral photodiode, the division of the monochromatic light being utilized to detect the optical wavelength; the division of the monochromatic light results in a current difference between the two anodes, the current difference being used to determine the optical wavelength; the linear variable optical filter is configured to limit a wavelength of the monochromatic light received by the lateral photodiode to be in a range of 1400-1700 nm; the linear variable optical filter is configured to limit a wavelength of the monochromatic light received by the lateral photodiode to be in a range of 900-1400 nm; the lateral photodiode includes an Indium Gallium Arsenide material or Germanium or other materials electro optically responsive to light from 800 nm to 1700 nm range; the lateral photodiode includes a Silicon material, wherein the linear variable optical filter is configured to limit a wavelength of the monochromatic light received by the lateral photodiode to be in a range of 300 nm-1000 nm; the lateral photodiode is configured to receive monochromatic light in either a front side illuminated configuration or a backside illuminated configuration; and a plurality of reference diodes on a first side and a second side of the lateral photodiode, the reference diodes providing a narrow measurement of the optical wavelength.

According to another exemplary embodiment of the invention, another optical detector system is provided. The optical detector system includes a moveable light source to provide light, and an optical encoder. The optical encoder includes a multi-lane lateral photodiode configured to receive light from the moveable light source. The optical encoder is configured to detect a position of the moveable light source.

According to other embodiments of the invention, the optical detector system recited in the immediately preceding paragraph may have one or more of the following features: the optical encoder includes a cooling element to cool the multi-lane lateral photodiode; the cooling element includes a thermoelectric cooler, the lateral photodiode being mounted on the thermoelectric cooler; the light received by the multi-lane lateral photodiode is divided between two respective anodes of each lane of the multi-lane lateral photodiode, the division of the light being utilized to detect the position of the moveable light source; the division of the light results in a current difference between the two respective anodes of each lane of the multi-lane lateral photodiode, the current difference being used to detect the position of the moveable light source; the moveable light source configured in a line beam projection moves about a rotative axis, the position of the moveable monochromatic light source detected by the optical encoder being an angular position; one or more optical elements configured to receive monochromatic light from the light source, and for directing the monochromatic light to the optical encoder; a computer system configured to detect the position of the moveable light source; the multi-lane lateral photodiode is configured to receive monochromatic light in either a front side illuminated configuration or a backside illuminated configuration; and the optical encoder includes a plurality of reference diodes on a first side and a second side of the lateral photodiode, the reference diodes providing a narrow measurement used to detect the position of the moveable light source.

According to another exemplary embodiment of the invention, a method of detecting an optical wavelength of monochromatic light is provided. The method includes the steps of: (a) providing a lateral photodiode configured to receive the monochromatic light; (b) disposing a linear variable optical filter in a path between the monochromatic light and the lateral photodiode; (c) receiving the monochromatic light with the lateral photodiode; and (d) detecting the optical wavelength of the monochromatic light by analyzing the monochromatic light received by the lateral photodiode.

According to other embodiments of the invention, the method recited in the immediately preceding paragraph may have one or more of the following features: the lateral photodiode provided in step (a) is a multi-lane lateral photodiode; step (c) includes dividing the monochromatic light received by the lateral photodiode such that the monochromatic light varies by lateral position with respect to wavelength between two respective anodes of each lane of the multi-lane lateral photodiode, the linear variable optical filter being skewed with respect to the multi-lane lateral photodiode such that the division of the monochromatic light between the respective anodes of each lane varies across each lane of the multi-lane lateral photodiode; a step of cooling the lateral photodiode with a cooling element; the cooling element includes a thermoelectric cooler, and the lateral photodiode is mounted on the thermoelectric cooler; step (c) includes dividing the monochromatic light received by the lateral photodiode between two anodes of the lateral photodiode, and step (d) includes analyzing the divided monochromatic light received by the lateral photodiode to detect the optical wavelength; the dividing of the monochromatic light results in a current difference between the two anodes, the current difference being analyzed in step (d) to determine the optical wavelength; step (b) includes limiting a wavelength of the monochromatic light received by the lateral photodiode using the linear variable optical filter to be in a range of 1400 nm to 1700 nm; step (b) includes limiting a wavelength of the monochromatic light received by the lateral photodiode using the linear variable optical filter to be in a range of 800 nm to 1700 nm; step (b) includes limiting a wavelength of the monochromatic light received by the lateral photodiode using the linear variable optical filter to be in a range of 300 nm to 1000 nm; step (c) includes receiving the monochromatic light by the lateral photodiode in either a front side illuminated configuration or a backside illuminated configuration; and a step of providing a plurality of reference diodes on a first side and a second side of the lateral photodiode for providing a narrow measurement of the optical wavelength.

According to another exemplary embodiment of the invention, a method of detecting a position of a moveable light source is provided. The method includes the steps of: (a) providing an optical encoder including a multi-lane lateral photodiode configured to receive light from a moveable light source; (b) receiving light from the moveable light source at the multi-lane lateral photodiode; and (c) detecting a position of the moveable light source based on light received during step (b).

According to other embodiments of the invention, the method recited in the immediately preceding paragraph may have one or more of the following features: a step of cooling the multi-lane lateral photodiode with a cooling element; the cooling element includes a thermoelectric cooler, the lateral photodiode being mounted on the thermoelectric cooler; step (b) includes dividing the light received by the multi-lane lateral photodiode between two respective anodes of each lane of the multi-lane lateral photodiode, and step (c) includes analyzing the divided light received by the multi-lane lateral photodiode to detect the position of the moveable light source; the dividing of the light results in a current difference between the two respective anodes of each lane of the multi-lane lateral photodiode, the current difference being analyzed in step (c) to detect the position of the moveable light source; the moveable light source configured in a line beam projection moves about a rotative axis, the position of the moveable monochromatic light source detected by the optical encoder being an angular position; step (c) includes using a computer system to detect a position of the moveable light source based on light received during step (b); step (b) includes receiving the light by the multi-lane lateral photodiode in either a front side illuminated configuration or a backside illuminated configuration; and a step of providing a plurality of reference diodes on a first side and a second side of the multi-lane lateral photodiode for providing a narrow measurement used to detect the position of the moveable light source.

It is to be understood that both the foregoing general description and the following detailed description are exemplary, but are not restrictive, of the disclosure.

### BRIEF DESCRIPTION OF THE DRAWINGS

The disclosure is best understood from the following detailed description when read in connection with the accompanying drawing. Included in the drawing are the following figures:

FIG. 1A is a top block diagram view of a packaged optical encoder in accordance with an exemplary embodiment of the invention;

FIG. 1B is a detailed view of elements of the optical encoder in of FIG. 1A;

FIG. 2A is a top block diagram view of another packaged optical encoder in accordance with another exemplary embodiment of the invention;

FIG. 2B is a detailed view of elements of the optical encoder in of FIG. 2A;

FIG. 3A is a top block diagram view of yet another packaged optical encoder in accordance with another exemplary embodiment of the invention;

FIG. 3B is a detailed view of elements of the optical encoder in of FIG. 3A;

FIGS. 4-10 are top block diagram views of various optical encoders in accordance with various exemplary embodiments of the invention;

FIG. 11 is block diagram view of an optical detector system in accordance with various exemplary embodiments of the invention;

FIG. 12 is a flow diagram illustrating a method of detecting an optical wavelength of monochromatic light in accordance with an exemplary embodiment of the invention; and

FIG. 13 is a flow diagram illustrating a method of detecting a position of a moveable light source in accordance with another an embodiment of the invention.

### DETAILED DESCRIPTION

According to certain exemplary embodiments of the invention, a lateral photodiode (LPD) may be used in combination with a linear variable optical filter to enable the precision determination (e.g., with a sub nanometer resolution) of optical wavelength. Analog signals (e.g., voltage signals, current signals, etc.) from the lateral photodiode may be processed to determine the optical wavelength. The resolution and sensor speed (bandwidth) can further be improved with a multi-lane lateral photodiode, and with subsequent post processing of analog signals from the multi-lane lateral photodiode.

For example, when the linear variable optical filter is overlayed with respect to the lateral photodiode, the optical wavelength of light from a light source may be controlled to a predetermined range (e.g., 1400-1700 nm, 900-1400 nm, 800-1700 nm, 300-1000 nm, etc.) according to the linear variable optical filter. When light (e.g., having a single wavelength) from a monochromatic light source shines on the lateral photodiode, electrical current divides between two anodes of the lateral photodiode. By processing signals from the lateral photodiode (e.g., current or voltage signals corresponding to the division between the two anodes), and because the filter is a linear filter, the optical wavelength of the light may be accurately determined.

Using such techniques may produce a higher resolution and higher bandwidth sensing mechanism for single color precision wavelength determination in optical systems when compared to a conventional Optical K Clock (i.e., a Mach Zehnder Interferometer). Such conventional Optical K Clocks are used to sense wavelength by counting pulses like an encoder.

Benefits of such techniques according to the invention include enabling wavelength determinations that are not time based - such that a static wavelength measurement can be accurately determined. Further, according to such aspects of the invention, the wavelength determinations are made largely independent of the incident light intensity.

Lateral photodiodes utilized in connection with the invention may include various materials such as: a Silicon material; an Indium Gallium Arsenide material or Germanium or other materials electro optically responsive to light from 800 nm to 1700 nm range; among other materials.

Linear variable optical filters (e.g., linear variable optical filters 104a, 104b, 104c, 104d, 104e, 104f, etc.) are configured to limit a wavelength of the monochromatic light received by the lateral photodiode to be in a range of, for example: 1400-1700 nm; 900-1400 nm; 300 nm-1000 nm; etc. Of course, other wavelength ranges are contemplated.

According to certain exemplary embodiments of the invention, the light sources utilized provide invisible light (e.g., thermal wavelength light, light having a wavelength above visible light, and often light having a wavelength above infrared light, etc.).

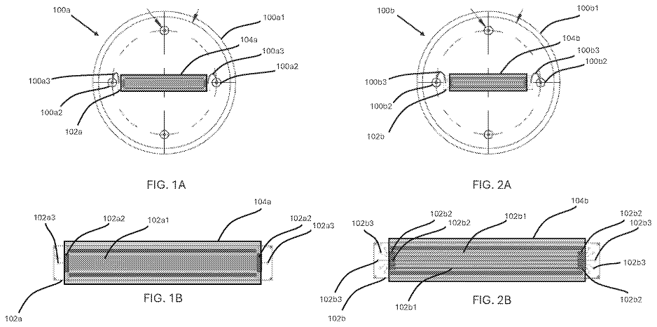

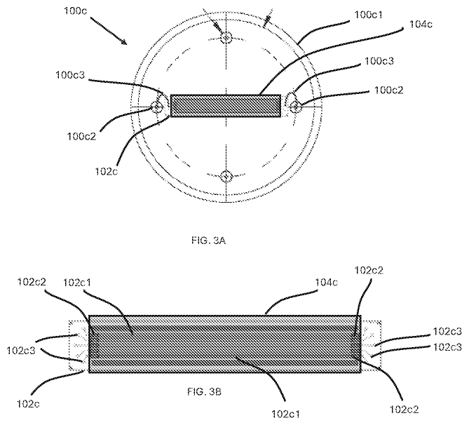

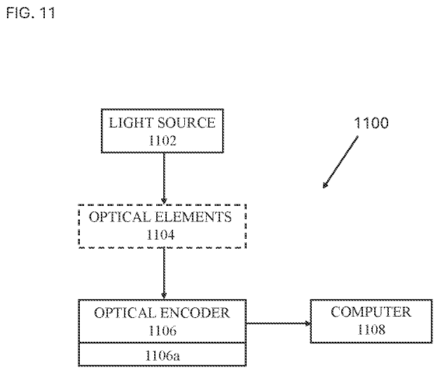

Resolution of the wavelength detection and/or position detection may be improved by cooling the linear photodiodes (single or multi-lane), for example, to reduce the dark current (e.g., noise floor) of the photodiodes. Cooling elements may be provided to lateral photodiodes. An exemplary cooling element is a thermo electric cooler, where the lateral photodiode may be mounted on the thermo electric cooler. While none of FIGS. 1A-1B, 2A-2B, 3A-3B, and 4-10 explicitly illustrate a cooling element, such cooling elements may be included in any of those optical encoders, or in connection with other embodiments within the scope of the invention (e.g., see cooling element 1106a in FIG. 11).

Lateral photodiode within the scope of the invention may be configured to receive monochromatic light in either a front side illuminated configuration or a backside illuminated configuration.

FIG. 1A illustrates a packaged optical encoder 100a configured to detect an optical wavelength of monochromatic light from a light source. Optical encoder 100a includes a housing 100a1 (e.g., a can and a lens encapsulating the photodetector assembly), a photodetector assembly 102a, and a linear variable optical filter 104a. Photodetector assembly 102a (detailed in FIG. 1B) includes a lateral photodiode 102a1 configured to receive monochromatic light, anodes 102a2 (at each end of lateral photodiode 102a1), and bonding locations 102a3 (where a bonding location is provided for each anode). An exemplary lateral photodiode 102a1 has a length of 12 mm, and a width of 1 mm. Wire loops 100a3 provide electrical interconnection between each bonding location 102a3 and corresponding conductive pin 100a2 (or other conductive structure) of optical encoder 100a. Linear variable optical filter 104a is disposed in a path between the monochromatic light and lateral photodiode 102a1.

When the monochromatic light is received by lateral photodiode 102a1, the light is divided such that the monochromatic light varies by lateral position with respect to wavelength between the two anodes 102a2. The division of the monochromatic light between the two anodes 102a2 is utilized to detect the optical wavelength. For example, the division of the monochromatic light results in a current difference between the two anodes 102a2, where the current difference is used to determine the optical wavelength.

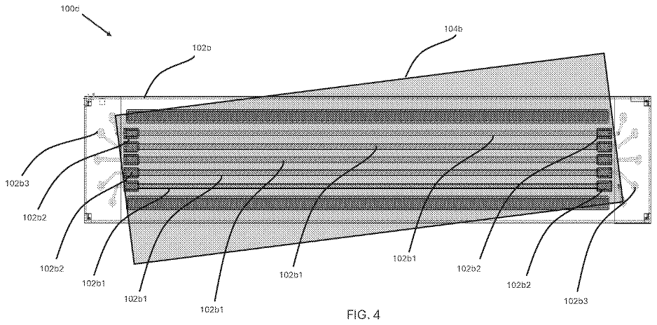

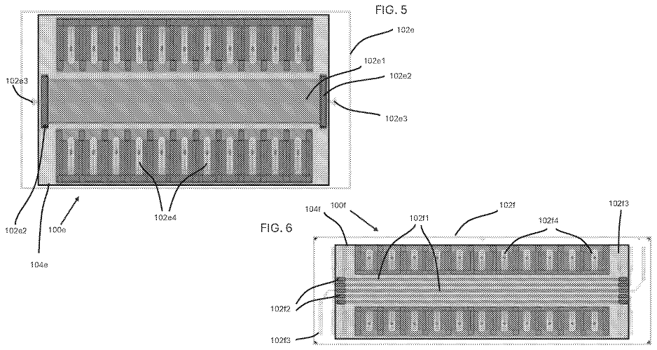

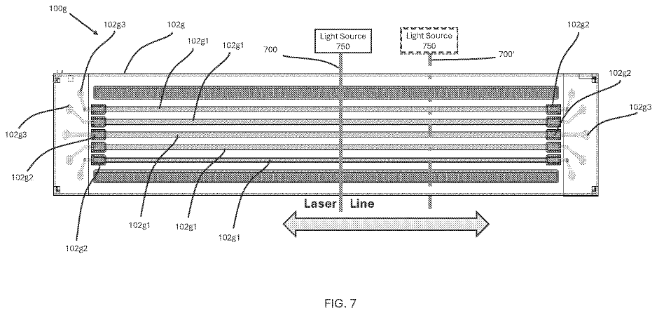

Although FIGS. 1A-1B illustrate a single lane lateral photodiode (i.e., lateral photodiode 102a1), additional benefits (e.g., reduced capacitance, noise reduction, etc.) may be provided with multi-lane lateral photodiodes (i.e., 5 channel arrays) such as shown in FIGS. 2A-2B (e.g., having a 12 mm length, and a thin channel width such as 0.1 mm per channel) and FIGS. 3A-3B (e.g., having a 12 mm length, and a wide channel width such as 0.2 mm per channel). Such multi-lane lateral photodiodes tend to improve a wavelength resolution detection of the optical wavelength, and/or provide an improved electrical bandwidth to increase the speed of detection of the optical wavelength.

FIG. 2A illustrates a packaged optical encoder 100b configured to detect an optical wavelength of monochromatic light from a light source. Optical encoder 100b includes a housing 100b1 (e.g., a can and a lens encapsulating the photodetector assembly), a photodetector assembly 102b, and a linear variable optical filter 104b. Photodetector assembly 102b (detailed in FIG. 2B) includes a plurality of lateral photodiodes 102b1 (i.e., a multi-lane lateral photodiode) configured to receive monochromatic light, anodes 102b2 (at each end of lateral photodiode 102b1), and bonding locations 102b3 (where a bonding location is provided for each anode). Wire loops 100b3 provide electrical interconnection between each bonding location 102b3 and corresponding conductive pin 100b2 of optical encoder 100b. Linear variable optical filter 104b is disposed in a path between the monochromatic light and the lateral photodiodes 102b1.

FIG. 2B illustrates a packaged optical encoder 100c configured to detect an optical wavelength of monochromatic light from a light source. Optical encoder 100c includes a housing 100c1 (e.g., a can and a lens encapsulating the photodetector assembly), a photodetector assembly 102c, and a linear variable optical filter 104c. Photodetector assembly 102c (detailed in FIG. 3B) includes a plurality of lateral photodiodes 102c1 (i.e., a multi-lane lateral photodiode) configured to receive monochromatic light, anodes 102c2 (at each end of lateral photodiode 102c1), and bonding locations 102c3 (where a bonding location is provided for each anode). Wire loops 100c3 provide electrical interconnection between each bonding location 102c3 and corresponding conductive pin 100c2 of optical encoder 100c. Linear variable optical filter 104c is disposed in a path between the monochromatic light and the lateral photodiodes 102c1.

FIGS. 4-10 illustrate various optical encoders in a simplified form as compared to FIGS. 1A-1B, 2A-2B, and 3A-3B. For example, FIGS. 4-10 do not illustrate a housing for the optical encoders. Nonetheless, it is understood that additional elements (such as a housing) may be included in the embodiments of FIGS. 4-10.

Referring specifically to FIG. 4, an optical encoder 100d configured to detect an optical wavelength of monochromatic light from a light source is illustrated. Optical encoder 100d includes a photodetector assembly 102b and a linear variable optical filter 104b as in FIG. 2A. Linear variable optical filter 104 b is overlayed with respect to the lateral photodiodes 102b1 of photodetector assembly 102b. However, in FIG. 4, linear variable optical filter 104b is tilted/skewed with respect to lateral photodiodes 102b1 (the multi-lane photodiode) such that the division of the monochromatic light between the respective anodes of each lane varies across each lane of the multi-lane lateral photodiode. With the varied information from each of the lanes of the multi-lane lateral photodiode, the resolution of the wavelength detection is improved. More specifically, because of the skew/tilt of the linear variable optical filter 104b, each channel (i.e., each lane of the multi-lane photodiode) receives the monochromatic light at a different spot along its length, resulting in a sub pixeling effect. With the known skew/tilt angle, and further calculations and data processing (e.g., and denoising), a more accurate wavelength determination may be achieved.

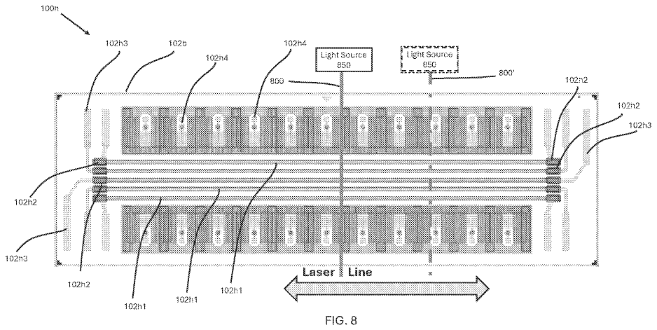

Referring specifically to FIG. 5, an optical encoder 100e configured to detect an optical wavelength of monochromatic light from a light source is illustrated. Optical encoder 100e includes a photodetector assembly 102e and a linear variable optical filter 104e. Photodetector assembly 102 e includes a lateral photodiode 102e1 configured to receive monochromatic light, anodes 102e2 (at each end of lateral photodiode 102e1), and bonding locations 102e3 (where a bonding location is provided for each anode). Linear variable optical filter 104e is disposed in a path between the monochromatic light and lateral photodiode 102e1. Optical encoder 102e functions similarly to optical encoder 102a shown in FIGS. 1A-1B. However, optical encoder 102e also includes a plurality of reference diodes 102e4 on a first side and a second side of lateral photodiode 102e1. Reference diodes 102e4 are used to provide a narrow measurement of the optical wavelength of the monochromatic light, thereby improving the accuracy of the determination of the optical wavelength.

Referring specifically to FIG. 6, an optical encoder 100f configured to detect an optical wavelength of monochromatic light from a light source is illustrated. Optical encoder 100f includes a photodetector assembly 102f and a linear variable optical filter 104f. Photodetector assembly 102f includes a plurality of lateral photodiodes 102f1 (i.e., a multi-lane lateral photodiode) configured to receive monochromatic light, anodes 102f2 (at each end of lateral photodiode 102f1), and bonding locations 102f3 (where a bonding location is provided for each anode). Linear variable optical filter 104f is disposed in a path between the monochromatic light and lateral photodiodes 102f1. Optical encoder 100 f functions similarly to optical encoder 100b shown in FIGS. 2A-2B. However, optical encoder 100f also includes a plurality of reference diodes 102f4 on a first side and a second side of lateral photodiodes 102f1. Reference diodes 102f4 are used to provide a narrow measurement of the optical wavelength of the monochromatic light, thereby improving the accuracy of the determination of the optical wavelength.

While FIGS. 1A-1B, 2A-2B, 3A-3B, and 4-6 primarily relate to optical encoders for detecting an optical wavelength of monochromatic light from a light source, the invention is not limited thereto. Exemplary embodiments of the invention (including the embodiments shown in FIGS. 7-10) relate to optical encoders configured to detect a position of the moveable light source (e.g., a light source moving along one or more linear axes, a light source moving about a rotative axis, etc.). Although FIGS. 7-10 illustrate detection of a position of a moveable light source (e.g., moveable along a linear axis, moveable about a rotative axis, etc.) using a fixed optical encoder, the invention may also be applied to the detection of a position of a moveable sensor (e.g., a moveable optical encoder) and a fixed light source.

Referring specifically to FIG. 7, an optical detector system is shown. The optical detector system includes a moveable light source 750 (not shown) to provide light 700 and an optical encoder 100 . Optical encoder 100g includes a photodetector assembly 102g. Photodetector assembly 102g includes a plurality of lateral photodiodes 102g1 (i.e., a multi-lane lateral photodiode) configured to receive light from moveable light source 750, anodes 102g2 (at each end of lateral photodiode 102g1), and bonding locations 102g3 (where a bonding location is provided for each anode). Optical encoder 100g is configured to detect a position of moveable light source 750.

Moveable light source 750 (e.g., a linear laser line projection provided, for example, via a Powell lens) moves along a linear motion axis (or axes) such that lateral photodiodes 102g1 determine a position of moveable light source 750 along the motion axis (or axes). Narrow multi-channel linear diodes such as the multi-lane lateral photodiodes 102g1 enable very good linearity of measurement. The measurement accuracy and resolution improve as the linear laser line narrows.

Referring specifically to FIG. 8, an optical detector system is shown. The optical detector system includes a moveable light source 850 (not shown) to provide light 800 and an optical encoder 100h. Optical encoder 100h includes a photodetector assembly 102h. Photodetector assembly 102h includes a plurality of lateral photodiodes 102h1 (i.e., a multi-lane lateral photodiode) configured to receive light from moveable light source 850, anodes 102h2 (at each end of lateral photodiode 102h1), and bonding locations 102h3 (where a bonding location is provided for each anode). Optical encoder 100h is configured to detect a position of moveable light source 850.

Moveable light source 850 (e.g., a linear laser line projection provided, for example, via a Powell lens) moves along a linear motion axis (or axes) such that lateral photodiodes 102h1 determine a position of moveable light source 850 along the motion axis (or axes). Narrow multi-channel linear diodes such as the multi-lane lateral photodiodes 102h1 enable very good linearity of measurement. The measurement accuracy and resolution improve as the linear laser line narrows.

Optical encoder 100h functions similarly to optical encoder 100g shown in FIG. 7. However, optical encoder 100h also includes a plurality of reference diodes 102h4 on a first side and a second side of lateral photodiodes 102h1. Reference diodes 102f4 are used to provide a narrow measurement of the position of moveable light source 850, thereby improving the accuracy of the determination of the position of the moveable light source 850.

In each of FIGS. 7 and 8, the light received by the respective multi-lane lateral photodiode is divided between the two respective anodes of each lane of the multi-lane lateral photodiode. The division of the light is utilized to detect the position of the moveable light source. For example, the division of the light may result in a current difference between the two respective anodes of each lane of the multi-lane lateral photodiode. The current difference is used to detect the position of the moveable light source.

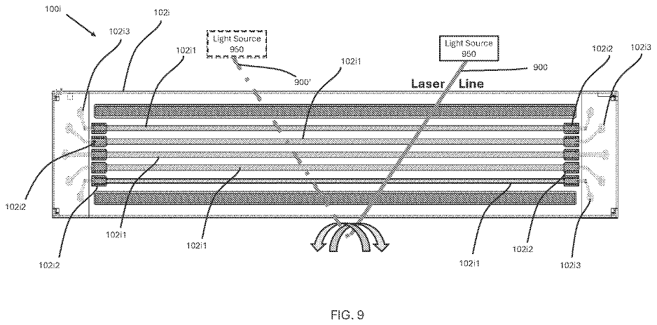

Referring specifically to FIG. 9, an optical detector system is shown. The optical detector system includes a moveable light source 950 (not shown) to provide light 900 and an optical encoder 100i. Moveable light source 950 is configured to move about a rotative axis. Optical encoder 100i includes a photodetector assembly 102i. Photodetector assembly 102i includes a plurality of lateral photodiodes 102i1 (i.e., a multi-lane lateral photodiode) configured to receive light from moveable light source 950, anodes 102i2 (at each end of lateral photodiode 102i1), and bonding locations 102i3 (where a bonding location is provided for each anode). Optical encoder 100i is configured to detect a rotative (e.g., angular) position of moveable light source 950 (e.g., the angle of a shaft of moveable light source 950).

Moveable light source 950 (e.g., a linear laser line projection provided, for example, via a Powell lens) moves about a rotative axis such that lateral photodiodes 102g1 determine a rotative position of moveable light source 950 about the rotative axis. Narrow multi-channel linear diodes such as the multi-lane lateral photodiodes 102g1 enable very good linearity of measurement. The measurement accuracy and resolution improve as the linear laser line narrows.

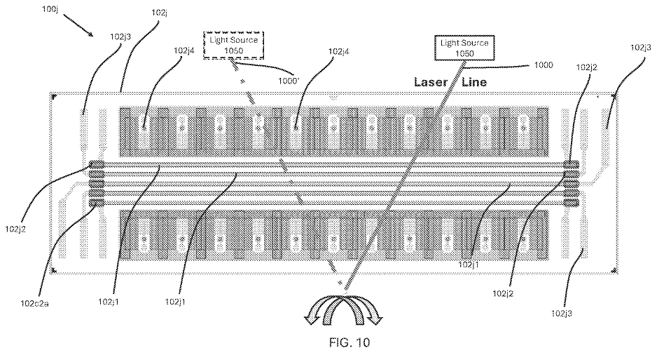

Referring specifically to FIG. 10, an optical detector system is shown. The optical detector system includes a moveable light source 1050 (not shown) to provide light 1000 and an optical encoder 100j. Moveable light source 1050 is configured to move about a rotative axis. Optical encoder 100j includes a photodetector assembly 102j. Photodetector assembly 102j includes a plurality of lateral photodiodes 102j1 (i.e., a multi-lane lateral photodiode) configured to receive light from moveable light source 1050, anodes 102j2 (at each end of lateral photodiode 102j1), and bonding locations 102j3 (where a bonding location is provided for each anode). Optical encoder 100j is configured to detect a rotative (e.g., angular) position of moveable light source 1050 (e.g., the angle of a shaft of moveable light source 1050).

Moveable light source 1050 (e.g., a linear laser line projection provided, for example, via a Powell lens) moves about a rotative axis such that lateral photodiodes 102j1 determine a rotative position of moveable light source 850 about the rotative axis. Narrow multi-channel linear diodes such as the multi-lane lateral photodiodes 102j1 enable very good linearity of measurement. The measurement accuracy and resolution improve as the linear laser line narrows.

Optical encoder 100j functions similarly to optical encoder 100i shown in FIG. 9. However, optical encoder 100j also includes a plurality of reference diodes 102j4 on a first side and a second side of lateral photodiodes 102j1. Reference diodes 102j4 are used to provide a narrow measurement of the rotative (e.g., angular) position of moveable light source 1050, thereby improving the accuracy of the determination of the rotative position of the moveable light source 1050.

In each of FIGS. 9 and 10, the light received by the respective multi-lane lateral photodiode is divided between the two respective anodes of each lane of the multi-lane lateral photodiode. The division of the light is utilized to detect the rotative position of the moveable light source. For example, the division of the light may result in a current difference between the two respective anodes of each lane of the multi-lane lateral photodiode. The current difference is used to detect the rotative position of the moveable light source.

FIG. 11 is a block diagram illustrating an optical detector system 1100 (e.g., an optical detector system including any of the optical encoders described herein). Optical detector system 1100 may be configured to: (i) detect the optical wavelength of monochromatic light; and/or (ii) detect a position of a moveable light source (e.g., see light sources 750, 850, 950, and 1050 described herein.

Optical detector system 1100 includes a light source 1102, optical elements 1104, optical encoder 1106, and computer 1108. Light source 1102 may be any light source within the scope of the invention, for example, a monochromatic light source or a polychromatic light source. Optical elements 1104 are configured to receive light from light source 1102, and for directing the light to optical encoder 1106. Optical encoder may be any optical encoder within the scope of the invention (e.g., optical encoder 100a, 100b, 100c, 100d, 100e, 100f, 100g, 100h, 100i, and/or 100j). Optical encoder 1106 includes a cooling element 1106a (e.g., a thermo electric cooler) for cooling lateral photodiodes of optical encoder 1106. For example, the lateral photodiodes of optical encoder 1106 may be mounted on cooling element 1106a. Computer 1108, in electrical communication with optical encoder 1106, is configured to detect (i) the optical wavelength of monochromatic light; and/or (ii) a position of a moveable light source (e.g., see light sources 750, 850, 950, and 1050 described herein).

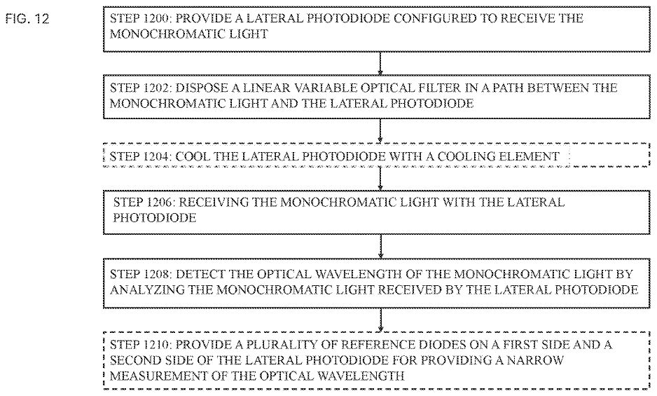

FIG. 12 is a flow diagram illustrating a method of detecting an optical wavelength of monochromatic light. At Step 1200, a lateral photodiode configured to receive the monochromatic light is provided. For example, see lateral photodiodes 102a1, 102b1, 102c1, 102e1, 102f1, etc. At Step 1202, a linear variable optical filter is disposed in a path between the monochromatic light and the lateral photodiode. For example, see linear variable optical filters 104a, 104b, 104c, 104e, 104f, etc. At optional Step 1204, the lateral photodiode is cooled with a cooling element (e.g., see cooling element 1106a in FIG. 11). At Step 1206, the monochromatic light is received with the lateral photodiode. At Step 1208, the optical wavelength of the monochromatic light is detected by analyzing the monochromatic light received by the lateral photodiode (e.g., the monochromatic light received by the lateral photodiode is analyzed by computer system 1108 in FIG. 11). At optional Step 1210, a plurality of reference diodes are provided on a first side and a second side of the lateral photodiode for providing a narrow measurement of the optical wavelength.

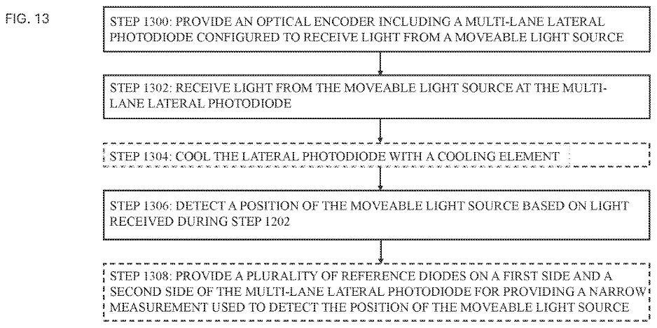

FIG. 13 is a flow diagram illustrating a method of detecting a position of a moveable light source. At Step 1300, an optical encoder including a multi-lane lateral photodiode configured to receive light from the moveable light source is provided (e.g., see optical encoders 100g, 100h, 100i, and 100j). At Step 1302, light from the moveable light source is received at the multi-lane lateral photodiode (e.g., see light 700 from light source 750, light 800 from light source 850, light 900 from light source 950, and light 1000 from light source 1050). At optional Step 1304, the lateral photodiode is cooled with a cooling element (e.g., see cooling element 1106a in FIG. 11). At Step 1306, a position (e.g., a linear position, a rotative/angular position, etc.) of the moveable light source is detected based on light received during Step 1302. At optional Step 1308, a plurality of reference diodes are provided on a first side and a second side of the lateral photodiode for providing a narrow measurement used to detect the position of the moveable light source.

In certain embodiments, the optical encoder comprises a lateral photodiode positioned to receive monochromatic light, with a linear variable optical filter disposed in the optical path between the light source and the photodiode. The encoder is configured to detect the optical wavelength of the incident monochromatic light by analyzing the division of light between the anodes of the photodiode. This configuration enables precise wavelength determination, which is largely independent of the intensity of the incident light.

The lateral photodiode of the optical encoder may be implemented as a multi-lane lateral photodiode. The use of multiple lanes improves the resolution of wavelength detection by providing additional channels for signal processing. This multi-lane configuration also enhances the electrical bandwidth, thereby increasing the speed at which the optical wavelength can be detected.

In some embodiments, the linear variable optical filter is skewed or tilted with respect to the multi-lane lateral photodiode. This arrangement causes the division of monochromatic light between the respective anodes of each lane to vary across the photodiode, resulting in a sub-pixeling effect. The varied information from each lane, combined with known skew angles and data processing, allows for more accurate wavelength determination.

A cooling element may be included to cool the lateral photodiode, which can be particularly beneficial for reducing dark current and noise floor, thereby improving measurement accuracy. The cooling element may be a thermoelectric cooler, with the lateral photodiode mounted directly on the cooler. This feature is applicable to both single-lane and multi-lane photodiode configurations.

The optical encoder may be configured such that the monochromatic light received by the lateral photodiode is divided between two anodes. The resulting current difference between the anodes is analyzed to determine the optical wavelength. This method leverages the linearity of the optical filter to achieve accurate wavelength detection.

The linear variable optical filter can be designed to limit the wavelength of the monochromatic light received by the lateral photodiode to specific ranges, such as 1400-1700 nm, 900-1400 nm, or 300-1000 nm. The choice of range depends on the application and the material properties of the photodiode. This flexibility allows the encoder to be tailored for different spectral regions.

The lateral photodiode may be fabricated from various materials, including Indium Gallium Arsenide, Germanium, or Silicon, depending on the desired spectral response. For example, Indium Gallium Arsenide or Germanium is suitable for detecting light in the 800-1700 nm range, while Silicon is appropriate for the 300-1000 nm range. The material selection ensures optimal sensitivity and performance for the intended wavelength range.

The optical encoder can be configured to receive monochromatic light in either a front side illuminated or backside illuminated configuration. This design flexibility allows integration into a variety of optical systems and packaging formats. The choice of illumination configuration may depend on the specific application requirements and system constraints.

In some embodiments, a plurality of reference diodes are provided on a first side and a second side of the lateral photodiode. These reference diodes enable narrow measurements of the optical wavelength, thereby improving the accuracy and reliability of the wavelength determination. The reference diodes can be used in both single-lane and multi-lane photodiode configurations.

The optical detector system may include a light source configured to provide monochromatic light, one or more optical elements for directing the light, and a computer system for processing the detected signals. The optical encoder, as described above, is integrated into this system to enable real-time detection of optical wavelength. The computer system may be programmed to analyze the signals from the photodiode and output the detected wavelength.

In another embodiment, the optical detector system includes a moveable light source and an optical encoder with a multi-lane lateral photodiode. The system is configured to detect the position of the moveable light source by analyzing the division of light received by the photodiode. This configuration is suitable for applications requiring precise position or angular detection of a light source.

The moveable light source may be configured to project a line beam and move along a linear or rotative axis. The position of the light source is detected by the optical encoder, which analyzes the current differences between the anodes of the multi-lane lateral photodiode. This enables accurate determination of both linear and angular positions of the moveable light source.

The optical detector system may further include optical elements for directing the light from the moveable source to the encoder, as well as a computer system for processing the detected signals. The system can be adapted for use in various measurement and control applications, including those requiring high linearity and resolution. The inclusion of reference diodes further enhances the accuracy of position detection.

A method of detecting an optical wavelength of monochromatic light is also provided. The method includes providing a lateral photodiode, disposing a linear variable optical filter in the optical path, receiving the monochromatic light, and detecting the wavelength by analyzing the received light. Optional steps include cooling the photodiode and providing reference diodes for improved measurement accuracy.

Similarly, a method of detecting the position of a moveable light source is disclosed. The method involves providing an optical encoder with a multi-lane lateral photodiode, receiving light from the moveable source, and detecting the position based on the received light. Optional steps include cooling the photodiode and using reference diodes to enhance the precision of position detection.

These embodiments and methods are not limited to the specific details described but may be modified within the scope and spirit of the disclosure. Various combinations of the described features may be implemented to address different application requirements. The invention thus provides a versatile platform for high-precision optical wavelength and position detection.

In certain embodiments, the optical encoder comprises a lateral photodiode positioned to receive monochromatic light, with a linear variable optical filter disposed in the optical path between the light source and the photodiode. The encoder is configured to detect the optical wavelength of the incident monochromatic light by analyzing the division of light between the anodes of the photodiode. This configuration enables precise wavelength determination, which is largely independent of the intensity of the incident light.

The lateral photodiode of the optical encoder may be implemented as a multi-lane lateral photodiode. The use of multiple lanes improves the resolution of wavelength detection by providing additional channels for signal processing. This multi-lane configuration also enhances the electrical bandwidth, thereby increasing the speed at which the optical wavelength can be detected.

In some embodiments, the linear variable optical filter is skewed or tilted with respect to the multi-lane lateral photodiode. This arrangement causes the division of monochromatic light between the respective anodes of each lane to vary across the photodiode, resulting in a sub-pixeling effect. The varied information from each lane, combined with known skew angles and data processing, allows for more accurate wavelength determination.

A cooling element may be included to cool the lateral photodiode, which can be particularly beneficial for reducing dark current and noise floor, thereby improving measurement accuracy. The cooling element may be a thermoelectric cooler, with the lateral photodiode mounted directly on the cooler. This feature is applicable to both single-lane and multi-lane photodiode configurations.

The optical encoder may be configured such that the monochromatic light received by the lateral photodiode is divided between two anodes. The resulting current difference between the anodes is analyzed to determine the optical wavelength. This method leverages the linearity of the optical filter to achieve accurate wavelength detection.

The linear variable optical filter can be designed to limit the wavelength of the monochromatic light received by the lateral photodiode to specific ranges, such as 1400-1700 nm, 900-1400 nm, or 300-1000 nm. The choice of range depends on the application and the material properties of the photodiode. This flexibility allows the encoder to be tailored for different spectral regions.

The lateral photodiode may be fabricated from various materials, including Indium Gallium Arsenide, Germanium, or Silicon, depending on the desired spectral response. For example, Indium Gallium Arsenide or Germanium is suitable for detecting light in the 800-1700 nm range, while Silicon is appropriate for the 300-1000 nm range. The material selection ensures optimal sensitivity and performance for the intended wavelength range.

The optical encoder can be configured to receive monochromatic light in either a front side illuminated or backside illuminated configuration. This design flexibility allows integration into a variety of optical systems and packaging formats. The choice of illumination configuration may depend on the specific application requirements and system constraints.

In some embodiments, a plurality of reference diodes are provided on a first side and a second side of the lateral photodiode. These reference diodes enable narrow measurements of the optical wavelength, thereby improving the accuracy and reliability of the wavelength determination. The reference diodes can be used in both single-lane and multi-lane photodiode configurations.

The optical detector system may include a light source configured to provide monochromatic light, one or more optical elements for directing the light, and a computer system for processing the detected signals. The optical encoder, as described above, is integrated into this system to enable real-time detection of optical wavelength. The computer system may be programmed to analyze the signals from the photodiode and output the detected wavelength.

In another embodiment, the optical detector system includes a moveable light source and an optical encoder with a multi-lane lateral photodiode. The system is configured to detect the position of the moveable light source by analyzing the division of light received by the photodiode. This configuration is suitable for applications requiring precise position or angular detection of a light source.

The moveable light source may be configured to project a line beam and move along a linear or rotative axis. The position of the light source is detected by the optical encoder, which analyzes the current differences between the anodes of the multi-lane lateral photodiode. This enables accurate determination of both linear and angular positions of the moveable light source.

The optical detector system may further include optical elements for directing the light from the moveable source to the encoder, as well as a computer system for processing the detected signals.

The system can be adapted for use in various measurement and control applications, including those requiring high linearity and resolution. The inclusion of reference diodes further enhances the accuracy of position detection.

A method of detecting an optical wavelength of monochromatic light is also provided. The method includes providing a lateral photodiode, disposing a linear variable optical filter in the optical path, receiving the monochromatic light, and detecting the wavelength by analyzing the received light. Optional steps include cooling the photodiode and providing reference diodes for improved measurement accuracy.

Similarly, a method of detecting the position of a moveable light source is disclosed. The method involves providing an optical encoder with a multi-lane lateral photodiode, receiving light from the moveable source, and detecting the position based on the received light. Optional steps include cooling the photodiode and using reference diodes to enhance the precision of position detection.

These embodiments and methods are not limited to the specific details described but may be modified within the scope and spirit of the disclosure. Various combinations of the described features may be implemented to address different application requirements. The invention thus provides a versatile platform for high-precision optical wavelength and position detection (p. 12).

Although illustrated and described above with reference to certain specific embodiments and examples, the present disclosure is nevertheless not intended to be limited to the details shown. Rather, various modifications may be made in the details within the scope and range of equivalents of the claims and without departing from the spirit of the disclosure.

What is claimed:

1. An optical encoder comprising:
a lateral photodiode configured to receive monochromatic light; and
a linear variable optical filter disposed in a path between the monochromatic light and the lateral photodiode,
wherein the optical encoder is configured to detect an optical wavelength of the monochromatic light.

2. The optical encoder of claim 1 wherein the lateral photodiode is a multi-lane lateral photodiode.

3. The optical encoder of claim 1 further comprising a cooling element to cool the lateral photodiode.
The optical encoder of claim 1 wherein the monochromatic light received by the lateral photodiode is divided between two anodes of the lateral photodiode, the division of the monochromatic light being utilized to detect the optical wavelength.

5. The optical encoder of claim 1 wherein the linear variable optical filter is configured to limit a wavelength of the monochromatic light received by the lateral photodiode to be in a range of 1400-1700 nm.

6. The optical encoder of claim 1 wherein the linear variable optical filter is configured to limit a wavelength of the monochromatic light received by the lateral photodiode to be in a range of 900-1400 nm.

7. The optical encoder of claim 1 wherein the lateral photodiode includes an Indium Gallium Arsenide material or Germanium or other materials electro optically responsive to light from 800 nm to 1700 nm range or a Silicon material, wherein the linear variable optical filter is configured to limit a wavelength of the monochromatic light received by the lateral photodiode to be in a range of 300 nm-1000 um.

8. An optical detector system comprising:
a light source configured to provide monochromatic light;
an optical encoder including (i) a lateral photodiode configured to receive monochromatic light from the light source, and (ii) a linear variable optical filter disposed in a path between the light source and the lateral photodiode,
wherein the optical encoder is configured to detect an optical wavelength of the monochromatic light.

9. The optical detector system of claim 8 further comprising one or more optical elements configured to receive monochromatic light from the light source, and for directing the monochromatic light to the optical encoder.

10. The optical detector system of claim 8 of claim 1 wherein the lateral photodiode is a multi-lane lateral photodiode wherein the multi-lane lateral photodiode improves a wavelength resolution detection of the optical wavelength.

11. The optical detector system of claim 10 wherein the monochromatic light received by the lateral photodiode is divided such that the monochromatic light varies by lateral position with respect to wavelength between two respective anodes of each lane of the multi-lane lateral photodiode, the linear variable optical filter being skewed with respect to the multi-lane lateral photodiode such that the division of the monochromatic light between the respective anodes of each lane varies across each lane of the multi-lane lateral photodiode.

12. The optical detector system of claim 8 wherein the optical encoder includes a cooling element to cool the lateral photodiode.

13. The optical detector system of claim 8 wherein the monochromatic light received by the lateral photodiode is divided between two anodes of the lateral photodiode, the division of the monochromatic light being utilized to detect the optical wavelength.

14. The optical detector system of claim 8 wherein the linear variable optical filter is configured to limit a wavelength of the monochromatic light received by the lateral photodiode to be in a range of 1400-1700 nm.

15. A method of detecting an optical wavelength of monochromatic light, the method comprising the steps of:
(a) providing a lateral photodiode configured to receive the monochromatic light;
(b) disposing a linear variable optical filter in a path between the monochromatic light and the lateral photodiode;
(c) receiving the monochromatic light with the lateral photodiode; and
(d) detecting the optical wavelength of the monochromatic light by analyzing the monochromatic light received by the lateral photodiode.

16. The method of claim 15 wherein the lateral photodiode provided in step (a) is a multi-lane lateral photodiode.

17. The method of claim 15 wherein step (c) includes dividing the monochromatic light received by the lateral photodiode such that the monochromatic light varies by lateral position with respect to wavelength between two respective anodes of each lane of the multi-lane lateral photodiode, the linear variable optical filter being skewed with respect to the multi-lane lateral photodiode such that the division of the monochromatic light between the respective anodes of each lane varies across each lane of the multi-lane lateral photodiode.

18. The method of claim 15 further comprising a step of cooling the lateral photodiode with a cooling element.

19. The method of claim 15 wherein step (c) includes dividing the monochromatic light received by the lateral photodiode between two anodes of the lateral photodiode, and step (d) includes analyzing the divided monochromatic light received by the lateral photodiode to detect the optical wavelength.

20. The method of claim 15 wherein step (b) includes limiting a wavelength of the monochromatic light received by the lateral photodiode using the linear variable optical filter to be in a range of 1400 nm to 1700 nm.
